(19) United States
(12) Patent Application Publication
(10) Pub. No.: US 2020/0317841 A1
(43) Pub. Date: Oct. 8, 2020

(54) CHEMICAL METHODS FOR PREPARATION OF COVALENT ADAPTABLE NETWORKS

(71) Applicant: Robert Bosch GmbH, Stuttgart (DE)

(72) Inventors: Kaushal SAGAR, Singapore (SG); Suresh PALALE, Singapore (SG)

(21) Appl. No.: 16/958,061

(22) PCT Filed: Mar. 9, 2018
(86) PCT No.: PCT/EP2018/055891

§ 371 Date: Jun. 25, 2020

(51) Int. Cl. C08F 255/02; C08J 3/28; C08J 11/10

(52) U.S. Cl. CPC C08F 255/023; C08J 3/28; C08J 2323/32; C08F 2810/20; C08J 2323/36; C08J 11/10

(57) ABSTRACT

A process for forming covalently cross-linked macromolecular networks, comprising reacting a compound of Formula (I), defined as R₁-L-X—R₃, with a compound of Formula (II), defined as HZ-R₂, to form a macromolecular compound of Formula (III), defined as R₁-L-Y, wherein R₁ represents a macromolecular polymer backbone, L represents an aryl or arylalkyl, R₂ independently represents an optionally substituted branched or linear C₁-C₁₀ alkane, a C₂-C₁₀ alkene, a C₂-C₁₀ alkyne, wherein the optional substituent is a second HZ-moiety or a carboxylic ester moiety, R₃ represents CF₃, H or C₁-C₁₀ alkane, X represents —C(O)—, —C(O)—C(CH₂)— or —C(CH₂)—C(O)—, Y represents —C(OH)(R₃)—Z—R₂, —C(O)—CH(R₃)—CH₂—Z—R₂ or —CH(C(O)R₃)—CH₂—Z—R₂; and Z represents S or NH. A covalently connected adaptable network formed by the process is also described.

### FIELD

The present invention relates to a process for the reversible formation of an adaptable network in thermosetting polymers.

### BACKGROUND INFORMATION

Polymeric materials are often differentiated into classes by their behavior upon heating: thermoplastics deform and flow at temperatures greater than their melting point, while thermosets remain intractable until the temperature is reached where destructive decomposition occurs. Such a classification scheme works well for polymers formed from highly exergonic reactions that are essentially irreversible; however, polymers that contain readily reversible covalent bonds capable of undergoing rearrangement can be used to create materials that fit neatly into neither category and have beneficial attributes of both. Furthermore, the living nature of such polymerizations causes unique post-polymerization behavior.

Thermoreversible adaptable polymers are materials capable of undergoing a reversible transition because they incorporate thermoreversible bonds. These thermoreversible covalent bonds are an order of magnitude stronger than hydrogen bonds, yet they permit the material to be thermoreversibly transitioned from a crosslinked solid to an oligomeric state. As a result, the material is both mechanically strong and readily able to heal fractures and other defects. Unfortunately, thermoreversible healing mechanisms are often limited by irreversible side reactions that occur at elevated temperatures. Additionally, strategies for selectively heating a material that is either spatially confined or surrounded by other thermally sensitive materials possess its own set of challenges.

In principle, most cross-linking reactions are reversible. However, realizing de-cross-linking often leads to complete and irreversible degradation of the polymer. Certain polymers, including those created by radical and ionic polymerization, often depolymerize when heated above a ceiling temperature, which is typically quite high. At such temperatures, irreversible degradation of other molecular structures generally occurs. A few polymers, including poly-(R-methyl styrene) and poly(isobutene), display more moderate ceiling temperatures (61° C. and 50° C., respectively). In condensation polymerizations, condensate removal favors the forward reaction, thus the retro-reaction is only achieved when the condensate is present in significant quantities.

Current state of technology of covalent adaptable networks for organic polymers is leveraging on Diels-Alder (DA) reactions and thiol-ene chemistry. For example, U.S. Pat. No. 6,933,361 describes thermally re-mendable polymeric materials that are made from multivalent furan monomers and multivalent maleimide monomers via the Diels-Alder (DA) reaction. The furan monomers are described as requiring at least three furan moieties and the maleimide monomers are described as requiring at least three maleimide monomers.

In organic chemistry, there are other synthetic routes available which can be utilized for formation of reversible covalent linkages.

Accordingly, there is a need for a process of reversibly forming a cross-linked polymer network without facing the disadvantages mentioned above.

### SUMMARY

In a first aspect according to the present inventon, there is provided an example process for forming covalently cross-linked macromolecular networks, comprising reacting a compound of Formula (I), defined as R₁-L-X—R₃, with a compound of Formula (II), defined as HZ-R₂, to form a macromolecular compound of formula (III), defined as R₁-L-Y, wherein

R₁ represents a macromolecular polymer backbone,

L represents an aryl or an arylalkyl,

R₂ independently represents an optionally substituted branched or linear C₁-C₁₀ alkane, a C₂-C₁₀ alkene, or a C₂-C₁₀ alkyne, wherein the optional substituent is a second HZ-moiety or a carboxylic ester moiety,

R₃ represents CF₃, H or C₁-C₁₀ alkane,

X represents —C(O)—, —C(O)—C(CH₂)— or —C(CH₂)—C(O)—,

Y represents —C(OH)(R₃)—Z—R₂, —C(O)—CH(R₃)—CH₂—Z—R₂ or —CH(C(O)R₃)—CH₂—Z—R₂; and

Z represents S or NH.

The reaction utilized in the process is an addition reaction. This provides enhanced reaction control and ease of reversibility, as the back reaction is the well-established elimination reaction. The addition reaction provides an improvement over other cross-linking reactions, for example condensation reactions, as a condensation reaction would require a constant balance of stoichiometry in order to ensure the reversibility of the reaction. The addition reaction may be facilitated by the employment of trifluoromethyl moieties in the macromolecular polymer of Formula (I), which results in an electron-withdrawing effect and thereby promotes the addition of an electron-donating, i.e., nucleophilic addition partner. The addition reaction can be carried out under moderate conditions i.e., temperature, solvents etc. where polymer degradation or chemical alteration of building blocks is generally avoided. Functional groups required to carry out above mentioned reactions can be easily attached to the macromonomer backbones, similar physical and chemical properties from reversible thermosets can be achieved, as in the case of conventional thermosetting polymers.

In a second aspect of the present invention, there is provided a covalently connected adaptable network formed by the example process as described above.

### BRIEF DESCRIPTION OF THE DRAWINGS

FIG. 1 shows a schematic representation of reversible covalent networks.

### DETAILED DESCRIPTION OF EXAMPLE EMBODIMENTS

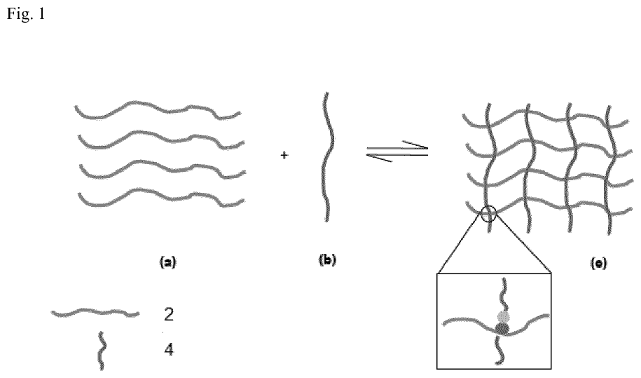

FIG. 1 shows a schematic representation of reversible covalent networks. 2 represents a macromolecular polymer according to a compound of Formula (I), 4 represents a cross-linker according to a compound of Formula (II), a) shows the thermosetting polymer with functional groups, b) shows a cross-linker molecule with matching functional end groups. There can be more than 2 functional groups which would result in higher cross-link density of the network polymer. c) represents a covalently cross-linked macromolecular network after reaction between both functional groups.

### DETAILED DESCRIPTION OF EXAMPLE EMBODIMENTS

The above mentioned problems of degradation of the polymer or difficulties with the reversibility of the cross-linking reaction can be solved by the process disclosed herein. Hence, the above problems can be avoided by implementing an addition reaction.

Accordingly, in a first aspect, there is provided a process for forming covalently cross-linked macromolecular networks, comprising reacting a compound of Formula (I), defined as R₁-L-X—R₃, with a compound of Formula (II), defined as HZ-R₂, to form a macromolecular compound of formula (III), defined as R₁-L-Y, wherein

R₁ represents a macromolecular polymer backbone,

L represents an aryl or an arylalkyl,

R₂ independently represents an optionally substituted branched or linear C₁-C₁₀ alkane, a C₂-C₁₀ alkene, or a C₂-C₁₀ alkyne, wherein the optional substituent is a second HZ-moiety or a carboxylic ester moiety,

R₃ represents CF₃, H or C₁-C₁₀ alkane,

X represents —C(O)—, —C(O)—C(CH₂)— or —C(CH₂)—C(O),

Y represents —C(OH)(R₃)—Z—R₂, —C(O)—CH(R₃)—CH₂—Z—R₂ or —CH(C(O)R₃)—CH₂—Z—R₂; and

Z represents S or NH.

The reaction may comprise, as a first starting material, a compound of Formula (I), which may be a macromolecular polymer comprising additional functional groups, wherein the compound of Formula (I) may be defined as R₁-L-X—R₃. R₁ signifies the macromolecular backbone. Suitable macromolecular backbones for the addition reaction may be derived from the group consisting of polyesters, epoxy polymers, polyacrylates, polystyrenes and a combination thereof. The macromolecular compound according to Formula (I) may optionally comprise a trifluoromethyl, or in conjunction with X as carbonyl, a trifluoro acetyl group, which may result in an electron-withdrawing effect, thereby promoting the addition of an electron-donating, i.e. nucleophilic addition partner. The trifluoro acetyl group may be grafted onto the vinyl backbone of the macromolecular backbone. Suitable macromolecular chains comprising a trifluoro acetyl functionality are selected from the group consisting of poly(p-vinyltrifluoroacetophenone), poly(trifluoroacetyl-p-xylylene) and poly(trifluoroacetyl-L-lysine). The macromolecule may also be described as a thermosetting polymer, for example, it may be a thermosetting polymer selected from the group consisting of epoxy, polyester and polyurethane. Bonded on the macromolecular backbone may be a linker L, which may be an aryl or an arylalkyl. The aryl or arylalkyl component of the linker may be linking the macromolecular backbone with the functional group X. Hence, the aryl component may be disubstituted. The disubstitution may be in ortho-, meta- or para-position to each other. Preferably, the disubstitution is in para position to each other. The optional alkyl component may be a C₁-C₁₀ alkyl moiety, preferably an ethyl moiety. ‘Aryl’ may refer to an optionally substituted phenyl moiety. The functional group X may be divalent, i.e. it connects to R₁ and R₃ on both sides of it. X may be selected from a group consisting of a carbonyl, i.e. —C(O)— and a carbonyl adjacent to a double bond, i.e. —(C(O)—C(CH₂)— or —C(CH₂)—C(O)—. Where the functional group X contains a double bond, this double bond may be geminally substituted, i.e. both substituents, either R₁ and —C(O)—, or —C(O)— and R₃ may be bound to the same carbon atom. The functional group X may be unsaturated, i.e. it contains sp²-hybridized atoms which may undergo an addition reaction. Hence, the functional group X would be altered during the process described above. As mentioned above, the functional group may be substituted with an additional moiety R₃. This moiety R₃ may be a trifluoroalkyl, for example CF₃. Alternatively, it may be hydrogen, thereby forming an aldehyde together with X, in the event X is —C(O)—. Alternatively, it may be a C₁-C₁₀ alkane, for example ethyl. The moiety R₃ may remain unchanged during the process. However, the functional group R₃ may be beneficial to the addition reaction by decreasing the electron-density of the unsaturated functional group X and therefore facilitate the addition reaction of an electron donating reaction partner.

The reaction may comprise, as a second starting material, a compound of Formula (II), which may be defined as HZ-R₂ and wherein Z represents S or NH. The functionality Z may be electron-rich, i.e. it may have a free electron pair. This free electron pair may have an electron-donating effect to the functional group X, thereby resulting in the formation of a covalent bond. The Z functionality may be altered in the addition reaction by forming a covalent bond with the unsaturated moiety X and donating the hydrogen atom it is bound to, to the atom adjacent to the atom forming the covalent bond with Z. Z may be divalent. Examples for a divalent Z are a thiol-moiety and a primary amine. Z may be substituted with at least one moiety R₂. R₂ may be independently an optionally substituted branched or linear C₁-C₁₀ alkane, a C₂-C₁₀ alkene, or a C₂-C₁₀ alkyne, wherein the optional substituent is a second HZ-moiety or a carboxylic ester moiety. In the event the optional substituent is an ester moiety, the HZ-moiety may be on the fragment of the carbonyl component of the ester. Alternatively, R₂ may be independently a branched or linear C₁-C₈ alkane, a branched or linear C₂-C₈ alkene or a C₂-C₈ alkyne, a branched or linear C₃-C₈ alkane, a branched or linear C₄-C₈ alkene or a C₄-C₈ alkyne, a branched or linear C₁-C₆ alkane, a C₂-C₆ alkene or a C₂-C₆ alkyne, a branched or linear C₁-C₄ alkane, a C₂-C₄ alkene or a C₂-C₄ alkyne, a branched or linear C₁-C₂ alkane, a C₂-C₃ alkene or a C₂-C₃ alkyne, a branched or linear C₄-C₁₀ alkane, a C₄-C₁₀ alkene or a C₄-C₁₀ alkyne. As mentioned above, R₂ may have two Z functionalities, for example a compound of Formula (II) may be a diamine, such as diethylene diamine. In cases wherein the compound of Formula (II) has more than one Z functionality, the plurality of Z functionalities may engage into the addition reaction with the compound of Formula (I).

The reaction may comprise, as a reaction product, a compound of Formula (III), which may be defined as R₁-L-Y. The nature of R₁, R₂, R₃ and Z may remain unchanged before and after the reaction. The unsaturated moiety in X may be altered to a saturated moiety in Y. This saturated moiety in Y may be, depending on the moiety X, a hydroxyl group C(OH) (for X being a carbonyl) or an ethyl moiety CHCH₂, having a carbonyl moiety adjacent to it (for X being a double bond adjacent to a carbonyl).

As mentioned before, the cross-linking reaction may be an addition reaction. Hence, the reaction may be characterized as an organic reaction where two or more molecules combine to form a larger one (the adduct). Addition reactions are limited to chemical compounds that have multiple bonds, such as molecules with carbon-carbon double bonds (alkenes). Molecules containing carbon-hetero double bonds like carbonyl (C═O) groups, can undergo addition, as they too have double-bond character.

An addition reaction is the reverse of an elimination reaction. There are two main types of polar addition reactions: electrophilic addition and nucleophilic addition. Addition reactions are also encountered in polymerizations and called addition polymerization. In the present case, as the unsaturated component X has a low electron density, the present addition reaction is classified as a nucleophilic addition reaction.

As mentioned before, the process as described above may be reversible. Hence, after the formation of the macromolecular network described with Formula (III), the reaction may be reversed. An exemplary reversible reaction is shown below in Scheme 1:

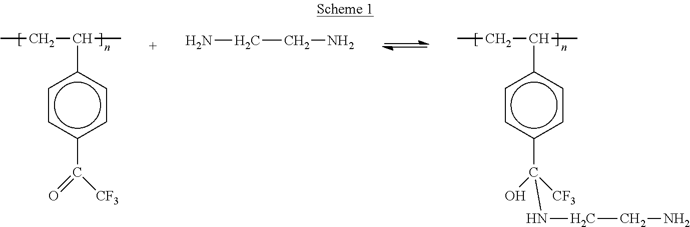

The back reaction type would be an elimination reaction. The starting material of the elimination reaction would be a network according to compounds defined as Formula (III). The reaction product of such an elimination reaction would be the compounds described as Formula (I) and Formula (II).

The reaction for the formation of compounds of Formula (III) from compounds of Formulae (I) and (II), may further comprise an energy source. This energy source may be selected from a light source, for example photoactivation, or from a thermal energy source, for example heat. Where the cross-linking reaction is thermally induced, the compounds of Formula (I) and (II) may be exposed to a temperature of about 40° C. to about 200° C., or about 50° C. to about 150° C., or about 50° C. to about 120° C. Alternatively, the reaction may proceed at room temperature, i.e. without a thermal energy source. Where the cross-linking reaction is activated by light, the compounds of Formula (I) and (II) may be exposed to a light source of about 200 nm to about 500 nm, optionally about 200 nm to about 450 nm, optionally about 220 nm to about 400 nm. In such a case, the reaction may further comprise a photo-initiator, which may be a peroxide. The peroxide may be selected from the group consisting of dicumyl peroxide, lauroyl peroxide, tert-butyl peroxide. They may be azo based thermal initiators such as azobisisobutyronitrile or azobiscyclohexanecarbonitrile. Alternatively, they may be phenones, such as acetophenone, benzophenone or dimethoxy phenylacetophenone. The photo-initiator may be added in sub-stoichiometric amounts. In various embodiments, the photo-initiator may be added as about 0.1-0.5 equivalents, or about 0.2-0.4 equivalents, or about 0.3 equivalents. Alternatively, the reaction may proceed in the absence of a photo-initiator.

The reaction time may be about 1 min to about 10 hours, or about 5 min to about 2 hours, or about 10 min, or about 1 hour.

In case a photo-initiator is used for the formation of a compound of Formula (III), the reverse reaction may be performed using a light source as defined above, which may result in de-crosslinking of the polymer network.

The formation of compounds of Formula (III) from compounds of Formulae (I) and (II) may further be carried out in the presence of an agent to lock (locking agent) the compound of Formula (III), meaning that the back reaction would be prevented. The locking agent may be added in sub-stoichiometric amounts. In various embodiments, the locking agent may be added as about 0.1-0.5 equivalents, or about 0.15-0.3 equivalents, or about 0.3 equivalents. The locking agent may be such that it forms a strong bond with a newly formed functional group of the compound of Formula (III). In the embodiment as described in Scheme 1, the agent to lock the compound of Formula (III) may be a silyl-containing agent. In this embodiment, the silyl forms a strong interaction with the —OH group of the hemiaminal, which shifts the reaction balance towards the compound of Formula (III). In one example, the silyl-containing agent may be N-trimethylsilylimidazole. The back reaction in this case may be performed by subjecting the compound of Formula (III) to the same reaction conditions, but without the locking agent. The elimination reaction may then occur, resulting in de-crosslinking of the polymer network.

The formation of compounds of Formula (III) from compounds of Formulae (I) and (II) may further be carried out in the presence of a solvent. Alternatively, there may be no solvent employed. Suitable solvents for this reaction may be selected from non-polar solvents, such as cyclopentane, hexane, cyclohexane, benzene, toluene, 1,4-dioxane, chloroform, diethyl ether or dichloromethane. Alternatively, the solvent may be selected from polar aprotic solvents, such as tetrahydrofuran, ethyl acetate, acetone, dimethylformamide, acetonitrile, dimethyl sulfoxide, nitromethane or propylene carbonate.

The formation of compounds of Formula (III) from compounds of Formulae (I) and (II) may further be carried out in the presence of a base. Suitable bases to be employed may be nitrogen bases, such as pyridine, trimethylamine, triethylamine or DIPEA.

In a preferred embodiment, a trifluoro acetyl functionalized group may form a reversible covalent bond with amines. In particular, R₃ may represent CF₃, X may represent —C(O)—, Z may represent NH and Y may represent —C(OH)(CF₃)—NH—R₂. Accordingly, a reaction sequence of a preferred embodiment may be represented with the following reaction scheme:

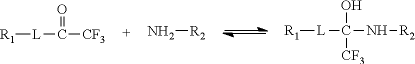

In an alternative preferred embodiment, a thiol-functionalized group may form a reversible covalent linkage with an aldehyde group. In particular, R₃ may represent H, X may represent —C(O)—, Z may represent S and Y may represent —CH(OH)—S—R₂. Accordingly, a reaction sequence of this preferred embodiment may be represented with the following reaction scheme:

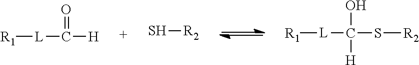

Yet in another preferred embodiment, a thiol-functionalized group may form a reversible covalent linkage with an enone (α-β-unsaturated carbonyl) group, wherein the double bond is adjacent to the linker. In particular, X may represent —C(CH₂)—C(O)—, Z may represent S and Y may represent —CH(C(O)R₃)—CH₂—Z—R₂. Accordingly, a reaction sequence of this preferred embodiment may be represented with the following reaction scheme:

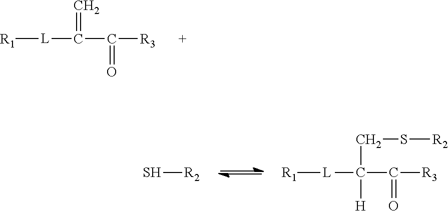

Yet in another preferred embodiment, a thiol-functionalized group may form a reversible covalent linkage with an enone (α-β-unsaturated carbonyl) group, wherein the carbonyl is adjacent to the linker. In particular, X may represent —C(O)—C(CH₂)—, Z may represent S and Y may represent —C(O)—CH(R₃)—CH₂—Z—R₂. Accordingly, a reaction sequence of this preferred embodiment may be represented with the following reaction scheme:

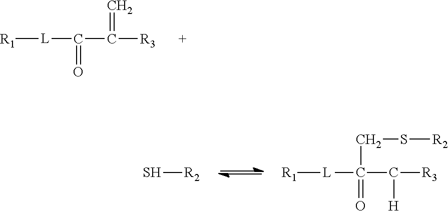

All above chemistry routes may be utilized in forming covalent adaptable networks in thermosetting polymers by adding one of the substituted functional groups on the polymer chain. Using the other substituent group as a crosslinker (functionality<2), reversible polymer networks may be formed using thermal, photo or any other energy source as per usual cross-linking techniques.

In a second aspect of the present invention, there is provided a covalently connected adaptable network formed by the process as described above.

The above disclosed chemical routes for formation of reversible networks can provide more flexibility while designing reversible polymer networks. This feature can be leveraged in designing a variety of reversible polymer networks according to its suitability, without being restricted to few known chemical routes.

### EXAMPLES

### Example 1: Trifluoro Acetyl Chemistry

In this example, the trifluoroacetyl pendant group on the polymer macromolecule acts as an electron acceptor group, readily reacting with electron donating diamines. A crosslinking reaction between the trifluoroacetyl carbonyl and the diamines in 1:1 molar ratio converts the trifluoroacetyl into a hemiaminal or zwitterion in diethyl ether under constant stirring for 1 hour at room temperature. As the reaction is reversible, the reaction requires shifting the reaction balance towards the hemiaminal formation, which is achieved by addition of N-trimethylsilylimidazole (0.2 M equivalent) to the solution. This results in locking of hemiaminal structure, thus the reverse reaction to form trifluoroacetyl group is impeded. De-crosslinking reaction is similarly carried out at room temperature for 1 hour under constant stirring in diethyl ether, in the absence of N-trimethylsilylimidazole. This results in formation of original structures through rearrangement of hemiaminal to amine and trifluoroacetyl macromolecule groups.

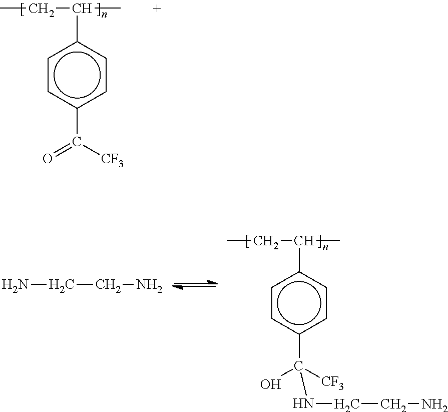

### Example 2: Hemithioacetyl Chemistry

5 equivalents of thiolated acetate molecule per unit of aldehyde pendant group in a macromolecule were reacted for 72 h at pH 1 under inert atmosphere.

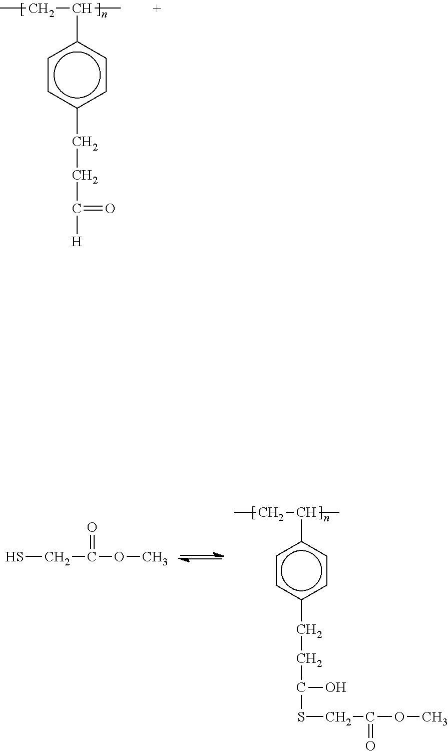

### Example 3: Thiol-enone Chemistry

5 equivalents of thiolated acetate molecule per unit of enone pendant group of a macromolecule were reacted at room temperature for 24 hr in acetonitrile or triethylamine.

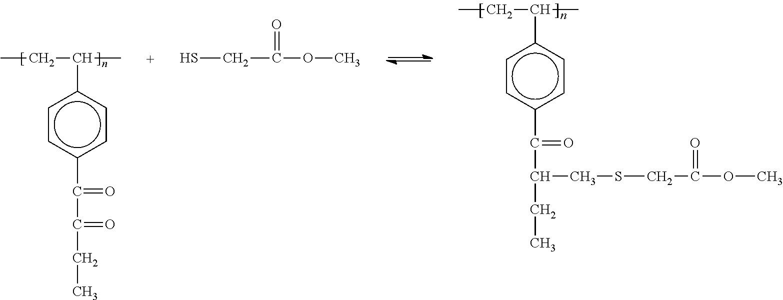

The thiol-based reversible macromolecular chemistry of Examples 2 and 3 is governed by photo initiated crosslinking and de-crosslinking reactions. 5 moles of thiolated acetate molecule to 1 mol of aldehyde or enone pendant group in a macromolecule is added to an organic solvent such as acetonitrile or trimethylamine at room temperature. A photo-initiator such as 2,2-dimethoxy-2-phenylacetophenone (0.3 equivalents) is added to the solution and irradiated at 365 nm for 10 min. Free radicals generated by light exposure from photo-initiator form thiol radicals. Thiol radical groups undergo addition reaction to an aldehyde or an enone group resulting in cross-linking reaction with a yield of >80%. For a de-crosslinking reaction, light exposure at 365 nm for 10 min on cross-linked macromonomer results in rearrangement and fragmentation of thiol-based crosslinks, resulting in replacing original crosslinks with new crosslinks, thereby reforming originally cross-linked polymer matrix.

1-10. (canceled)

11. A process for forming covalently cross-linked macromolecular networks, comprising:
reacting a compound of Formula (I), defined as R₁-L-X—R₃, with a compound of Formula (II), defined as HZ-R₂, to form a macromolecular compound of Formula (III), defined as R₁-L-Y;
wherein:
R₁ represents a macromolecular polymer backbone,
L represents an aryl or an arylalkyl,
R₂ independently represents an optionally substituted branched or linear C₁-C₁₀ alkane, or a C₂-C₁₀ alkene, or a C₂-C₁₀ alkyne, wherein the optional substituent is a second HZ-moiety or a carboxylic ester moiety,
R₃ represents CF₃, H or C₁-C₁₀ alkane,
X represents —C(O)—, —C(O)—C(CH₂)— or —C(CH₂)—C(O)—,
Y represents —C(OH)(R₃)—Z—R₂, —C(O)—CH(R₃)—CH₂—Z—R₂ or —CH(C(O)R₃)—CH₂—Z—R₂; and
Z represents S or NH.

12. The process of claim 11, wherein the process is reversible.

13. The process of claim 11, wherein the process further includes using an energy source.

14. The process of claim 13, wherein the cross-linking is thermally induced, by exposing the compounds of Formula (I) and (II) to a temperature from 40° C.-200° C.

15. The process of claim 13, wherein the cross-linking is activated by light, by exposing the compounds of Formula (I) and (II) to a light source of 200 nm-500 nm.

16. The process of claim 11, wherein the cross-linking reaction is an addition reaction.

17. The process of claim 11, wherein R₃ represents CF₃, X represents —C(O)—, Z represents NH, and Y represents —C(OH)(CF₃)—NH—R₂.

18. The process of claim 11, wherein R₃ represents H, X represents —C(O)—, Z represents S, and Y represents —CH(OH)—S—R₂.

19. The process of claim 11, wherein R₃ represents —C₁-C₁₀ alkane, X represents —C(O)—C(CH₂)—, Z represents S, and Y represents —C(O)—CH(—C₁-C₁₀ alkane)-CH₂—Z—R₂.

20. A covalently connected adaptable network formed by a process comprising:
reacting a compound of Formula (I), defined as R₁-L-X—R₃, with a compound of Formula (II), defined as HZ-R₂, to form a macromolecular compound of Formula (III), defined as R₁-L-Y;
wherein:
R₁ represents a macromolecular polymer backbone,
L represents an aryl or an arylalkyl,
R₂ independently represents an optionally substituted branched or linear C₁-C₁₀ alkane, or a C₂-C₁₀ alkene, or a C₂-C₁₀ alkyne, wherein the optional substituent is a second HZ-moiety or a carboxylic ester moiety,
R₃ represents CF₃, H or C₁-C₁₀ alkane,
X represents —C(O)—, —C(O)—C(CH₂)— or —C(CH₂)—C(O)—,
Y represents —C(OH)(R₃)—Z—R₂, —C(O)—CH(R₃)—CH₂—Z—R₂ or —CH(C(O)R₃)—(CH₂)—Z—R₂; and
Z represents S or NH.
